(19) United States
(12) Patent Application Publication
(10) Pub. No.: US 2013/0025358 A1
(43) Pub. Date: Jan. 31, 2013

(54) Deployment Mechanism for Well Logging Devices

(71) Applicants: Steven R. Radford, The Woodlands, TX (US); John G. Evans, The Woodlands, TX (US); Freeman L. Hill, Spring, TX (US)

(72) Inventors: Steven R. Radford, The Woodlands, TX (US); John G. Evans, The Woodlands, TX (US); Freeman L. Hill, Spring, TX (US)

(73) Assignee: Baker Hughes Incorporated, Houston, TX (US)

(21) Appl. No.: 13/191,185

(22) Filed: Jul. 26, 2011

(51) Int. Cl. G01V 3/18

(52) U.S. Cl. 73/152.02

(57) ABSTRACT

Devices and methods for logging a wellbore condition. A logging-on-demand tool is used which includes a logging tool housing assembly carried by a running string and a logging tool that is retained within the logging tool housing assembly and is selectively movable between a retracted position, wherein the logging tool is retained radially within the logging tool housing assembly, and a deployed position, wherein the logging tool is extended axially from the logging tool housing assembly

### BACKGROUND OF THE INVENTION

1. Field of the Invention

The invention relates generally to tools and methods used for logging of wellbore conditions. In certain particular aspects, the invention relates to systems and methods for selectively deploying logging devices and other tools in connection with hole-enlarging reaming operations.

2. Description of the Related Art

Wellbore logging instruments are generally relatively fragile and vulnerable to damage during run in operations, especially when conveyed on drill pipe or coiled tubing.

They can be damaged by drilling debris, ledges, wellbore restrictions and other forms of obstruction within the wellbore during run-in, making them inoperable before they reach the desired depth at which they will log wellbore conditions.

### SUMMARY OF THE INVENTION

The invention provides devices and methods for incorporating a logging instrument or other device into a deployable logging-on-demand tool. In a described example, a deployable logging-on demand tool includes a logging tool housing assembly and a logging tool that is retained within the logging tool housing assembly. The logging tool is moveably retained within the logging tool housing assembly and is generally protected during tripping into the wellbore by being substantially contained within the logging tool housing assembly. When desired, the logging tool can be deployed by selectively extending it axially outwardly from its protective logging tool housing assembly. Thereafter, logging operations can be conducted. If desired, the logging tool can then be selectively retracted into the logging tool housing assembly.

In a described embodiment, the logging tool housing assembly that protects the logging tool includes a hole-enlarging reaming bit, such as an EZCASE® or Core™ bit, which permits logging operations to be conducted in conjunction with operations to enlarge portions of the wellbore. The bit provides a central axial opening through which the logging tool can be disposed during deployment. Also in a described embodiment, the logging tool housing assembly includes an outer tubular housing and an inner mandrel that resides within the outer housing. The logging tool resides radially within the inner mandrel and is axially moveable with respect to the inner mandrel.

In described embodiments, the deployable logging-on-demand tool includes a valve mandrel that is affixed to the upper ends of both the outer housing and the inner mandrel. The valve mandrel, in conjunction with the outer housing and inner mandrel, preferably includes a deployment mechanism that permits the logging tool to be selectively extended from and retracted into and/or retained within the inner mandrel of the deployable on-demand logging tool. In a described embodiment, the deployment mechanism features a first fluid flow path in the form of a deployment fluid flowpath that will direct the flow of drilling fluid into a housing bore in the radial interior of the inner mandrel in a manner which will axially extend the logging tool axially outwardly from the radial interior of the deployment sub. Also in a described embodiment, the deployment mechanism features a second fluid flow path in the form of a retraction fluid flow path that directs the flow of drilling fluid along a path that will cause the logging tool to be retracted within the deployment sub. In the event that the logging tool is in an extended position, directing the flow of drilling fluid along the second fluid flow path will retract the logging tool into the deployment sub. In a described embodiment, the deployment mechanism also features a third flow path that will direct flow of drilling fluid in a normal circulation manner so as to lubricate the bit and/or clean the wellbore.

In a described embodiment, the flow of drilling fluid into the first or second flow paths is controlled by a valve piston that is responsive to the fluid flow rate of drilling fluid from the surface. In a described embodiment, the valve piston is disposed within a piston bore that is defined within the valve mandrel. Also in the described embodiment, the valve piston defines an axial blind bore within which has a valve piston fluid port that permits fluid to exit the blind bore. The valve piston fluid port may be selectively aligned with either of the first or second flow paths in order to selectively deploy the logging tool or retract the logging tool. In a described embodiment, the valve piston is spring biased to a first position within the piston chamber that aligns the valve piston fluid port with the flow path for retracting the logging tool.

According to an exemplary method of operation, the logging-on-demand tool is disposed into the wellbore on a running string and, in some embodiments, is operated to enlarge or ream the wellbore using the hole-enlarging reaming bit. During this stage of operation, drilling fluid is flowed into the running string at or below a first level of flow rate (“A”). Alternatively, the logging-on-demand tool may be disposed into the wellbore and operated to conduct logging without performing any reaming.

When a depth is reached at which it is desired to conduct logging, the rate of drilling fluid flow into the running string is increased to a second predetermined threshold level (“B”) that is sufficient to shift the valve piston within the valve mandrel. Drilling fluid is then flowed through the deployment fluid flowpath to move the logging tool to the deployed position. Logging can be conducted at depth and, if desired, logging can be conducted as the logging-on-demand tool is withdrawn from the wellbore.

If it is desired to retract the logging tool back into the logging tool housing assembly, an operator will either stop or significantly reduce the drilling fluid flow rate (below flow rate level “A”) to permit the valve piston within the valve mandrel to be shifted back to its initial position. Thereafter, drilling fluid is flowed into the running string at or around the first flow rate level “A.” As this fluid flows into the valve mandrel, it will be to directed along the retraction fluid flowpath, which will return the logging tool to its retracted position.

### BRIEF DESCRIPTION OF THE DRAWINGS

For a thorough understanding of the present invention, reference is made to the following detailed description of the preferred embodiments, taken in conjunction with the accompanying drawings, wherein like reference numerals designate like or similar elements throughout the several figures of the drawings and wherein:

FIG. 1 is a side, cross-sectional view of a wellbore containing a running string with a logging-on-demand tool constructed in accordance with the present invention.

FIGS. 2A and 2B are a side, cross-sectional view of portions of the logging-on-demand tool shown in FIG. 1, with the logging tool portion of the tool in a retracted position.

FIGS. 3A and 3B are a side, cross-sectional view of portions of the logging on-demand tool of FIGS. 2A and 2B, now with the logging tool portion of the tool in a deployed position.

FIG. 4 is an axial cross-section taken along lines 4-4 in FIG. 2B.

FIG. 5 is a side, cross-sectional view of the wellbore shown in FIG. 1, now with the running string being removed and logging being conducted.

### DETAILED DESCRIPTION OF THE PREFERRED EMBODIMENTS

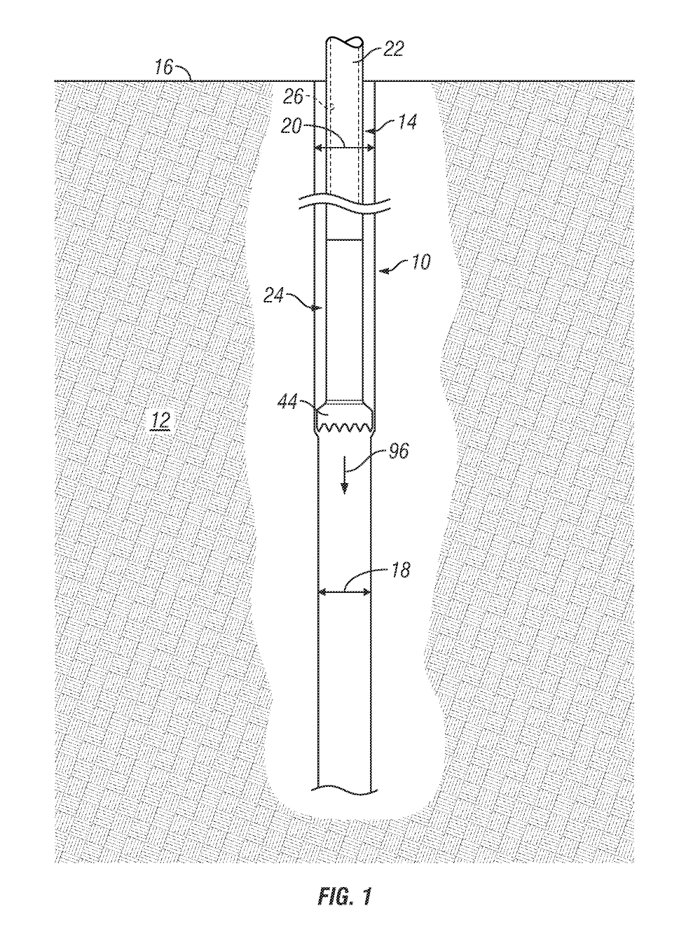

FIG. 1 depicts an exemplary wellbore 10 that has being formed in the earth 12. A running string, generally indicated at 14, is shown disposed within the wellbore 10. The running string 14 extends from the surface 16 and, in this example, is being used to enlarge/ream the diameter of the wellbore 10 from a first, reduced diameter 18 to a second, enlarged diameter 20. This reaming operation may be cutting virgin material from the wellbore 10 or, alternatively, the reaming operation may be conducted to re-enlarge the wellbore 10 after it has contracted following drilling. In another alternative embodiment, the running string 14 can be disposed into a wellbore without any enlarging/reaming being done. The running string 14 includes lengths of drill pipe 22 which are affixed to one another in a manner known in the art. An exemplary logging-on-demand tool 24, constructed in accordance with the present invention, is located on the distal end of the running string 14. The running string 14 defines a flowbore 26 along its length for the transmission of drilling fluid from the surface 16 down to the logging-on-demand tool 24.

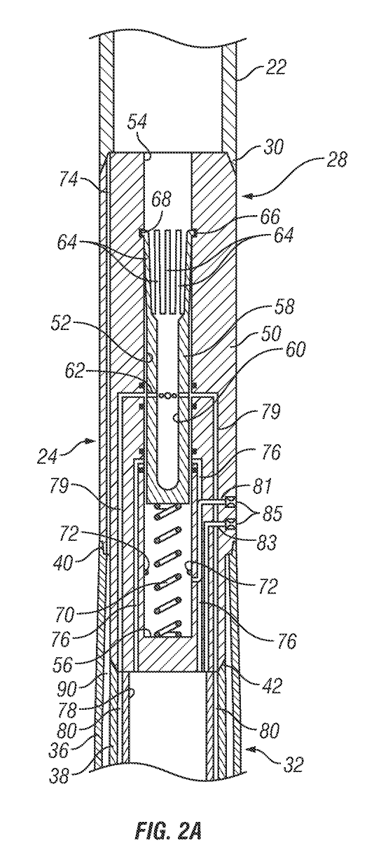

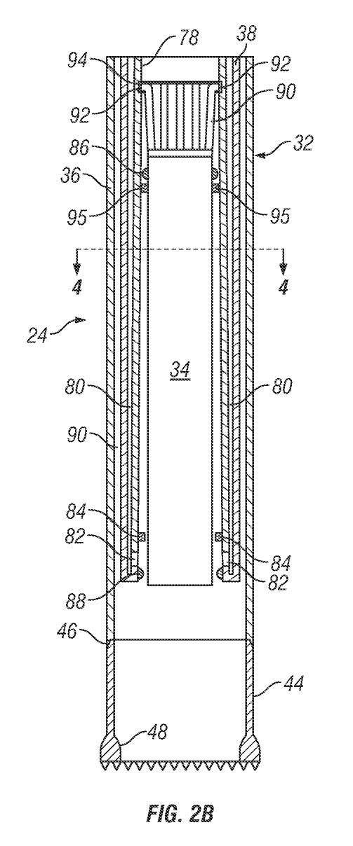

The logging-on-demand tool 24 is shown in greater detail in FIGS. 2A and 2B, 3A and 3B, and 4. The exemplary logging-on-demand tool 24 includes a valve mandrel 28 that is affixed by threaded connection 30 to drill pipe 22. The lower end of the valve mandrel 28 is affixed to a logging tool housing assembly, generally shown at 32. The logging tool housing assembly 32 is controlled by the valve mandrel 28 and is operable to selectively deploy and retract a logging tool 34. The exemplary logging tool 34 is generally cylindrical and typically incorporates a number of sensors that are capable of detecting desired wellbore conditions such as pressure, temperature, gamma, electrical resistivity, angle and azimuth. Typically, logging tools of this nature are customized to sense whichever wellbore conditions are desired by the well operator. In one embodiment, the logging tool 34 is a battery-powered, memory-based wellbore logging device of a type to known in the art. In alternative embodiments, the logging tool 34 might have power provided from the surface 14 using, for example, wired pipe to facilitate surface readout of wellbore parameters sensed by the logging tool 34.

The exemplary logging tool housing assembly 32 includes an outer housing 36 and an inner mandrel 38 that is located radially within the outer housing 36. The upper end of the outer housing 36 is affixed to the valve mandrel 28 at threaded connection 40. The inner mandrel 38 is affixed to the valve mandrel 28 at threaded connection 42.

In the depicted embodiment, a hole-enlarging or reaming drill bit 44 is secured to the lower end of the outer housing 36 at threaded connection 46. Suitable bits for use as the hole-enlarging bit 44 include the EZCASE® and Core™ bits which are available commercially from Baker Hughes Incorporated of Houston, Tex. The hole-enlarging bit 44 defines a central opening 48.

The exemplary valve mandrel 28 features a mandrel body 50 with a piston bore 52 defined within the body 50. The piston bore 52 has an open upper end 54 and a closed lower end 56. An axially moveable valve piston 58 is disposed within the piston bore 52. The valve piston 58 defines an axial blind bore 60 within. A plurality of lateral valve piston fluid ports 62 are formed through the valve piston 58 to permit fluid communication between the blind bore 60 and the region radially surrounding the valve piston 58. In one embodiment, a plurality of collets 64 extends axially upwardly from the valve piston 58.

The collets 64 each present a radially outwardly extending tab 66. The tabs 66 are shaped and sized to reside within an annular groove 68 that is inscribed in the piston bore 52. In the initial, run-in position shown in FIG. 2A, the tabs 66 reside within the groove 68.

A compression spring 70 is also disposed within piston bore 52 between the valve piston 58 and the closed lower end 56 of the piston bore 52. The spring 70 biases the valve piston 58 upwardly within the piston bore 52. Landing shoulders 72 are also disposed within the piston bore 52.

A number of fluid passages are defined within the body 50 of the valve mandrel 28. A circulation fluid passage 74 extends axially through the body 50 and serves to transmit drilling fluid from the drill pipe 22 through the valve mandrel 28 to the logging tool housing assembly 32 below. A plurality of deployment fluid passages 76 extend between the piston bore 52 and the housing bore 78 that is defined within the inner mandrel 38 of the logging tool housing assembly 32. Retraction fluid passages 79 extend from the piston bore 52 to the inner mandrel 38. In the depicted embodiment, there are eight retraction fluid passages 79, but there may be more or fewer than eight, if desired. Additionally, bleed nozzle passages 81 and 83 are formed within the body 50 of the valve mandrel 28. The first bleed nozzle passage 81 extends from the piston bore 52 to the exterior of the valve mandrel 28. The second bleed nozzle passage 83 extends from the housing bore 78 to the exterior of the valve mandrel 28. Bleed nozzles 85 are preferably provided for each of these passages and permit excess fluid that is within the piston bore 52 or the housing bore 78 to be bled out to the exterior of the valve mandrel 28 during operation. Conversely, the passages 81, 83 and bleed nozzles 85 permit fluid from the surrounding wellbore 10 to flow into the piston bore 52 or housing bore 78.

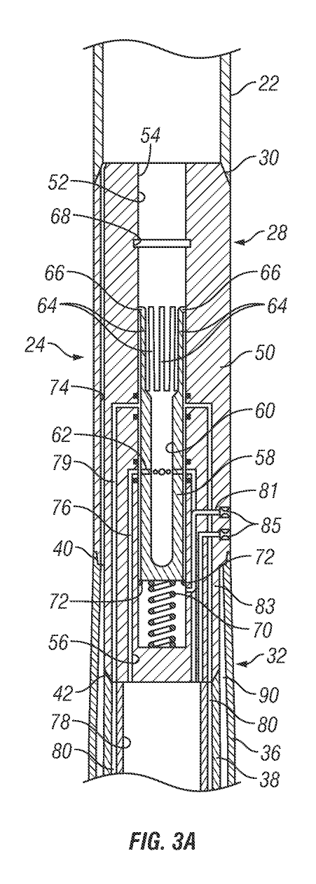

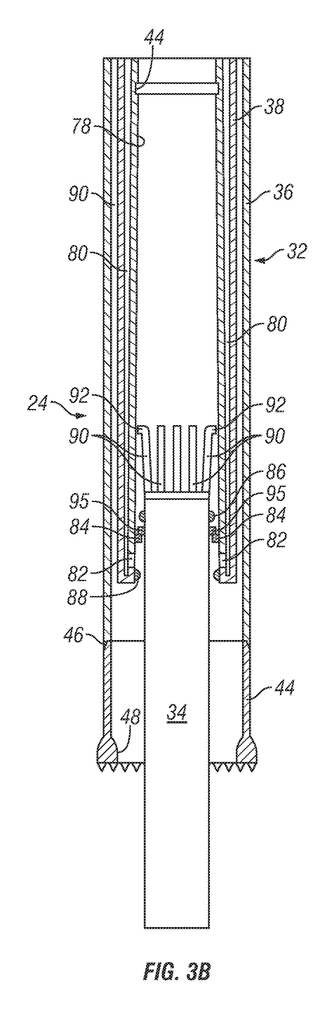

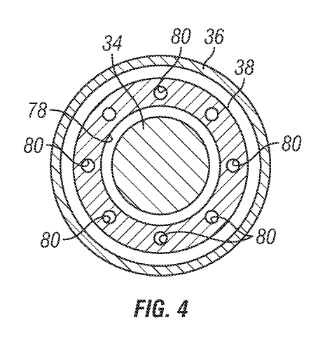

Several axial fluid flowbores 80 are formed within the inner mandrel 38. As can be seen in FIGS. 2B and 3B, radial ports 82 interconnect the axial flowbores 80 with the housing bore 78. Referring once again to FIGS. 2B and 3B, it can be seen that the inner mandrel 38 includes landing shoulders 84 which project radially inwardly into the housing bore 78. In addition, fluid seal 86 projects radially outwardly from the logging tool 34, and fluid seal 88 projects radially inwardly into the housing bore 78. FIG. 4 illustrates that there are eight fluid flowbores 80 which are angularly spaced around the inner mandrel 38. There may be more or fewer than eight, if desired. However, the fluid flowbores 80 should be formed to be aligned with the retraction fluid passages 79, and it is suggested that there be the same number and angular spacing for the flowbores 80 as for the fluid passages 79 in order to accomplish this.

Collets 90 extend axially from the logging tool 34 and include outwardly-directed tabs 92 that are shaped and sized to reside within an annular groove 94 that is inscribed within the housing bore 78. The collets 90, tabs 92 and groove 94 provide a releasable latch for the valve piston 58. Those of skill in the art will understand that the releasable latch may have a number of other constructions, such as releasable balls and matching detents. In the initial run-in, retracted position shown in FIG. 2B, the tabs 92 reside within the groove 94. Lugs 95 protrude radially from the logging tool 34.

In exemplary operation, the running string 14 is disposed into the wellbore 10 and may be used to expand/ream the wellbore 10 as illustrated in FIG. 1 by moving the logging-on-demand tool 24 in the direction of arrow 96. At this time, the logging-on-demand tool 24 is in the configuration shown in FIGS. 2A and 2B. During this portion of operation, drilling fluid is flowed down through the flowbore 26 of the running string 14 at a first predetermined level (“A”) that is below the point necessary to shift the valve piston 58 within the piston bore 52. Fluid is transmitted through the circulation fluid passage 74 to the coaxial space 90 located between the outer housing 36 and the inner mandrel 38 and down to lubricate the bit 44. Also during operation, drilling fluid is also transmitted into the blind bore 60 of the valve piston 58. Drilling fluid entering the blind bore 60 will be transmitted via lateral valve piston fluid ports 62 outside of the valve piston 58. Because the collets 64 of the valve piston 58 are secured within the groove 68 of the piston bore 52, the valve piston fluid ports 62 are aligned with the retraction fluid passages 79 causing drilling fluid to flow downwardly into the axial fluid flowbores 80 within the inner mandrel 38. The fluid that enters the axial flowbores 80 is then transmitted through the radial ports 82 into the housing bore 78 and acts upwardly against the fluid seal 86. This fluid pressure acting upon the fluid seal 86 will tend to bias the logging tool 34 axially upwardly within the housing bore 78. Some fluid flowing into the housing bore 78 above the seal 88 may flow upwardly and out of the housing bore 78 through bleed nozzle passage 83. This upward flow, together with the interconnection of the collets 90 with the groove 94 will also help to retain the logging tool 34 in the retracted position shown in FIG. 2B.

When desired, the logging tool 34 can be deployed from the logging-on-demand tool 24 by selectively extending the logging tool 34 outwardly through the central opening 48 of the bit 44, as illustrated in FIG. 3B. To move the logging tool 34 from the retracted position shown in FIG. 2B to the extended position shown in FIG. 3B, an operator at the surface increases the rate of flow of drilling fluid to or above a predetermined level (“B”) that is sufficient to cause the collets 64 of the valve piston 58 to be released from the groove 68 and the bias of the compression spring 70 overcome. It is suggested that this predetermined level be set significantly above normal operating levels for drilling fluid flow rate so as to avoid inadvertent deployment of the logging tool 34. The valve piston 58 will then shift downwardly within the piston bore 52 (see FIG. 3A) and bottom out against landing shoulders 72. At this point, the valve piston fluid ports 62 will be aligned with the deployment fluid passages 76. Drilling fluid will flow through the deployment fluid passage 76 and into the housing bore 78. Fluid pressure within the housing bore 78 above the logging tool 34 will urge the logging tool 34 downwardly through the central opening 48 of the bit 44 (see FIG. 3B). The lugs 95 protruding from the logging tool 34 contact the landing shoulders 84 of the housing bore 78, thereby ensuring that the logging tool 34 does not completely exit the housing bore 78.

In this deployed position, the logging tool 34 can be operated to detect wellbore conditions. Since the construction and operation of logging tools is well understood in the industry, they will not be described in any detail here.

If it is desired to return the logging-on-demand tool 24 to its retracted position, the operator will stop the flow of drilling fluid, or significantly reduce the flow of drilling fluid (below level “A”), into the running string 14. The flow rate reduction permits the spring 70 to bias the valve piston 58 upwardly within the piston bore 52 to the position shown in FIG. 2A. The tabs 66 of the collets 64 will reengage the groove 68 in the piston bore 52. In this upper position, the valve piston fluid ports 62 of the valve piston 58 are once again aligned with the retraction fluid passages 79. The operating will now begin to flow drilling fluid into the running string 14 at the first, reduced flow rate “A.” Drilling fluid entering the retraction fluid passages 79 will flow downwardly into the axial fluid flowbores 80 within the inner mandrel 38. As this fluid flows through the ports 82, it will cause the logging tool 34 to be retracted back upwardly into the housing bore 78.

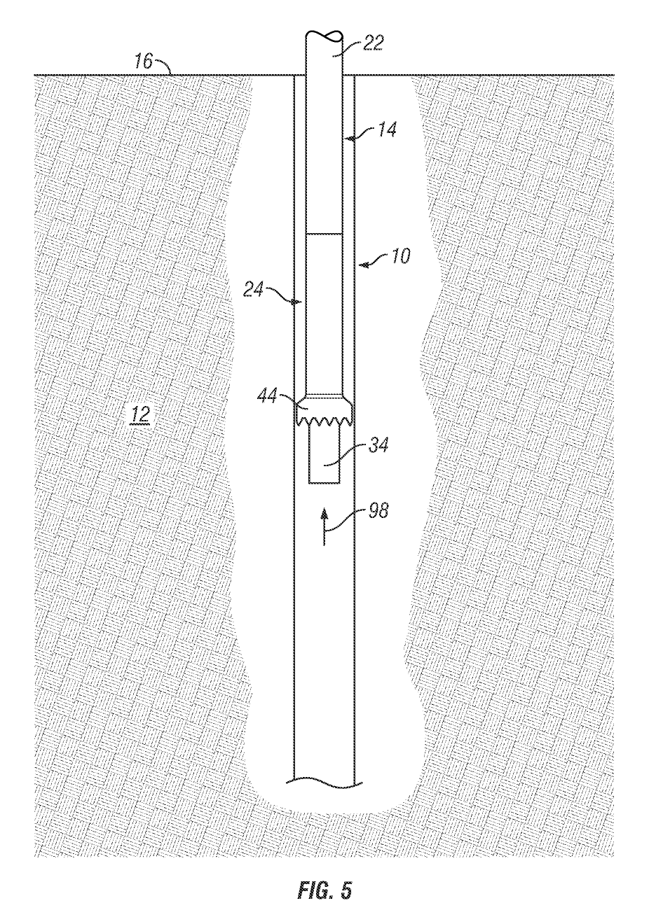

According to an exemplary method of operation for logging wellbore conditions, the logging-on-demand tool 24 is disposed into the wellbore 10 and rotated by the drilling string 14 to cause the drill bit 44 to enlarge the wellbore 10. The logging-on-demand tool 24 is moved downwardly in the direction of arrow 96 in FIG. 1. At this time, the logging-on-demand tool 24 is in the retracted position shown in FIGS. 2A and 2B. After the logging-on-demand tool 24 has reached the desired depth, downward movement of the is tool 24 in the direction of arrow 96 is halted. The flow rate of drilling fluid into the drilling string 14 is increased to a predetermined level sufficient to cause the valve piston 58 to move axially downwardly within the piston bore 52. Drilling fluid will then be transmitted through the deployment fluid passage 76 to the upper portion of the housing bore 78, and the logging tool 34 deploys as described above. Thereafter, the logging-on-demand tool 24 monitors various wellbore conditions. In one embodiment, the logging-on-demand tool 24 is operable to monitor desired wellbore conditions as the tool 24 and drilling string 14 are being withdrawn from the wellbore 10, as illustrated by arrow 98 in FIG. 5.

Those of skill in the art will recognize that numerous modifications and changes may be made to the exemplary designs and embodiments described herein and that the invention is limited only by the claims that follow and any equivalents thereof.

What is claimed is:

1. A logging-on-demand tool for use in a wellbore, comprising:
a logging tool housing assembly that is carried by a running string; and
a logging tool that is, retained within the logging tool housing assembly and is selectively movable between a retracted position, wherein the logging tool is retained radially within the logging tool housing assembly, and a deployed position, wherein the logging tool is extended axially from the logging tool housing assembly.

2. The logging-on-demand tool of claim 1 further comprising a hole-enlarging reaming bit operably associated with the logging tool housing assembly for enlarging a portion of the wellbore, and wherein the hole-enlarging reaming bit has a central opening through which the logging tool is disposed when deployed.

3. The logging-on-demand tool of claim 1 wherein the logging tool housing assembly comprises:
an outer housing; and
an inner mandrel radially disposed within the outer housing, the logging tool being disposed within the inner mandrel.

4. The logging-on-demand tool of claim 1 wherein the logging tool is secured in the retracted position within the logging tool housing assembly by a releasable latch.

5. The logging-on-demand tool of claim 1 wherein the logging tool housing assembly further comprises a valve mandrel that controls movement of the logging tool between the retracted and deployed positions.

6. The logging-on-demand tool of claim 5 wherein the valve mandrel comprises:
a valve mandrel body defining a piston bore;
a valve piston moveably disposed within the piston bore between first and second positions;
a blind bore formed within the valve piston; and
a valve piston fluid passage within the valve piston to communicate fluid from the blind bore through the valve piston.

7. The logging-on-demand tool of claim 6 wherein the valve mandrel further comprises:
a deployment fluid passage formed within the valve mandrel body, the logging tool being moved to the deployed position when fluid is flowed through the deployment fluid passage;
a retraction fluid passage formed within the valve mandrel body, the logging tool being moved to the retracted position when fluid is flowed through the retraction fluid passage;
the valve piston fluid port aligning with the retraction fluid passage when the valve piston is in its first position; and
the valve piston fluid port aligning with the deployment fluid passage when the valve piston is in its second position.

8. The logging-on-demand tool of claim 7 wherein the valve piston is biased toward the first position by a spring.

9. A logging-on-demand tool for use in a wellbore, comprising:
a logging tool housing assembly that is carried by a drill string;
a logging tool that is retained within the logging tool housing assembly and is selectively movable between a retracted position, wherein the logging tool is retained radially within the logging tool housing assembly, and a deployed position, wherein the logging tool is extended axially from the logging tool housing assembly; and
the logging tool housing assembly having a valve mandrel that controls movement of the logging tool between the retracted and deployed positions.

10. The logging-on-demand tool of claim 9 further comprising a hole-enlarging reaming bit operably associated with the logging tool housing assembly for drilling a portion of the wellbore.

11. The logging-on-demand tool of claim 9 wherein the valve mandrel comprises:
a valve mandrel body defining a piston bore;
a valve piston moveably disposed within the piston bore between first and second positions;
a blind bore formed within the valve piston; and
a valve piston fluid passage within the valve piston to communicate fluid from the blind bore through the valve piston.

12. The logging-on-demand tool of claim 11 wherein the valve mandrel further comprises:
a deployment fluid passage formed within the valve mandrel body, the logging tool being moved to the deployed position when fluid is flowed through the deployment fluid passage;
a retraction fluid passage formed within the valve mandrel body, the logging tool being moved to the retracted position when fluid is flowed through the retraction fluid passage;
the valve piston fluid port aligning with the retraction fluid passage when the valve piston is in its first position; and
the valve piston fluid port aligning with the deployment fluid passage when the valve piston is in its second position.

13. The logging-on-demand tool of claim 12 wherein the valve piston is biased toward the first position by a spring.

14. The logging-on-demand tool of claim 9 wherein the logging tool housing assembly comprises:
an outer housing; and
an inner mandrel radially disposed within the outer housing, the logging tool being disposed within the inner mandrel.

15. The logging-on-demand tool of claim 9 wherein the logging tool is secured in the retracted position within the logging tool housing assembly by a releasable latch.

16. A method of logging a wellbore condition with a logging tool comprising the steps of:
a) disposing a logging-on-demand tool within a wellbore, the logging-on demand tool having a logging tool housing assembly carried by a running string, and a logging tool that is retained within the logging tool housing assembly and selectively movable between a retracted position, wherein the logging tool is retained radially within the logging tool housing assembly, and a deployed position, wherein the logging tool is extended axially from the logging tool housing assembly;
b) moving the logging tool from the retracted position to the deployed position; and
c) logging the wellbore condition with the logging tool.

17. The method of claim 16 wherein the step of moving the logging tool further comprises increasing the flow rate of drilling fluid to the logging-on-demand tool to move the logging tool to the deployed position.

18. The method of claim 16 further comprising the step of moving the logging tool from the deployed position to the retracted position.

19. The method of claim 16 wherein the logging-on-demand tool further comprises a hole-enlarging reaming bit, and the step of disposing the logging-on-demand tool within the wellbore further comprises enlarging a portion of the wellbore with the hole enlarging reaming bit.
